(19) United States
(12) Patent Application Publication
(10) Pub. No.: US 2009/0327609 A1
(43) Pub. Date: Dec. 31, 2009

(54) Performance based cache management

(76) Inventors: Bruce Fleming, Beaverton, OR (US); Ticky Thakkar, Portland, OR (US)

Correspondence Address: Caven & Aghevli LLC;c/o CPA Global, P.O. BOX 52050, MINNEAPOLIS, MN, 55402, US

(21) Appl. No.: 12/215,914

(22) Filed: Jun. 30, 2008

(51) Int. Cl. G06F 12/08; G06F 1/26

(52) U.S. Cl. 711/118; 713/300; 711/E12.017

(57) ABSTRACT

Methods and apparatus to manage cache memory are disclosed. In one embodiment, an electronic device comprises a first processing unit, a first cache memory, and a first cache controller, and a power management module, wherein the power management module determines at least one operating parameter for the cache memory and passes the at least one operating parameter for the cache memory to a cache controller. Further, the first cache controller manages the cache memory according to the at least one operating parameter, and the power management module evaluates, in the power management module, operating data for the cache memory from the cache controller, and generates, in the power management module, at least one modified operating parameter for the cache memory based on the operating data for the cache memory from the cache controller.

### BACKGROUND

The present disclosure generally relates to the field of electronics. More particularly, embodiments relate to performance based cache management in electronic devices.

Many electronic devices include utilize cache memory to improve the performance of a processor in the electronic device, typically by reducing memory access latency. Some electronic devices such as, e.g., multi-core processors, utilize multiple cache memory modules. Adroit management of cache memory offers opportunities to save power while maintaining adequate operating parameters.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 is a schematic illustration of an electronic apparatus, according to embodiments.

FIG. 2 is a schematic illustration of a memory configuration in a processor in an electronic apparatus, according to embodiments.

FIGS. 3 and 4 are flow diagrams which illustrate cache management operations, according to an embodiment.

FIGS. 5 and 6 are schematic illustrations of embodiments of computing systems which may be utilized to implement various embodiments discussed herein.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention.

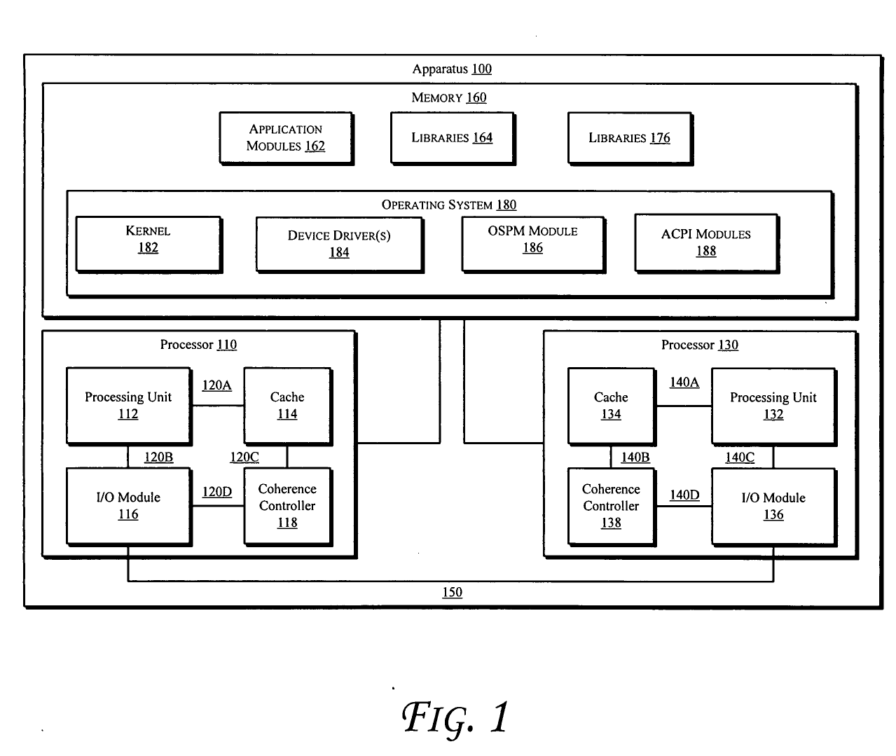

FIG. 1 is a schematic illustration of an electronic apparatus 100, according to an embodiment. Referring to FIG. 1, electronic apparatus 100 may comprise one or more processors 110, 130. Processor 110 may comprise a processing unit 112, a cache memory module 114, an input-output (I/O) module 116, and a coherence controller 118. Similarly, processor 130 may comprise a processing unit 132, a cache memory module 134, an input-output (I/O) module 136, and a coherence controller 138. In one embodiment, apparatus 100 may be a multi-core processor.

The various components of processors 110 may be coupled by one or more communication busses 120A, 120B, 120C, 120D, 120E which will be referred to collectively herein by reference numeral 120. The various components of processors 130 may be coupled by one or more communication busses 140A, 140B, 140C, 140D, 140E which will be referred to collectively herein by reference numeral 140. Further, processors 110, 130 may be coupled by a communication bus 150. Electronic apparatus 100 further comprises a memory module 160 coupled to processors 110, 130 by communication busses 120E, 140E. In one embodiment, the communication busses 120, 130, and 150 may be implemented as point-to-point busses.

The processors 110, 130 may be any processor such as a general purpose processor, a network processor that processes data communicated over a computer network, or other types of a processor including a reduced instruction set computer (RISC) processor or a complex instruction set computer (CISC). The processing units 112, 132 may be implemented as any type of central processing unit (CPU) such as, e.g., an arithmetic logic unit (ALU).

The memory module 160 may be any memory such as, e.g., Random Access Memory (RAM), Dynamic Random Access Memory (DRAM), Random Operational Memory (ROM), or combinations thereof. The I/O modules 116, 136 may include logic to manage one or more input/output ports on the respective communication busses 120, 130, 150 and the memory module 160.

In one embodiment, cache memory units 114, 134 may be embodied as write-back cache modules. The cache modules 114, 134 temporarily stores data values modified by the respective processors 110, 130, thereby reducing the number of bus transactions required to write data values back to memory module 160. In the embodiment depicted in FIG. 1 the cache modules 114, 134 are integrated within the respective processors 110, 130. In alternate embodiments, the cache modules 114, 134 may be external to the processors 110, 130, and coupled by a communication bus.

In some embodiments, the coherence controllers 118, 138 manage operations to maintain cache coherency in cache modules 114, 118. For example, when processing unit 112 modifies a data value, the modified data value exists in its cache module 114 before it is written back to memory 160. Thus, until the data value in cache module 114 is written back to the memory module 160, the memory module 160 and other cache units (such as cache 134) will contain a stale data value.

Coherence controllers 118, 138 may implement one or more techniques to maintain cache coherency between cache modules 114, 138 and memory module 160. Cache coherency techniques typically utilize coherency status information which indicates whether a particular data value in a cache unit is invalid, modified, shared, exclusively owned, etc. While many cache coherency techniques exist, two popular versions include the MESI cache coherency protocol and the MOESI cache coherency protocol. The MESI acronym stands for the Modified, Exclusive, Shared and Invalid states while the MOESI acronym stands for the Modified, Owned, Exclusive, Shared and Invalid states. In an alternate embodiment, cache controllers 118, 138 may implement a bus broadcasting technique to maintain cache coherency. For example, in multiple-bus systems bus transactions initiated on each bus may broadcast to other buses in the system.

In an alternate embodiment, cache controllers 118, 138 may implement directory-based cache coherency methods. In directory techniques, the main memory subsystem maintains memory coherency by storing extra information with the data. The extra information in the main memory subsystem may indicate 1) which processor or processors have obtained a copy of a data value and 2) the coherency status of the data values. For example, the extra information may indicate that more than one processor shares the same data value. In yet another example, the extra information may indicate that only a single processor has the right to modify a particular data value.

In an alternate embodiment, cache controllers 118, 138 may implement a bus interconnect cache coherency technique in which coherency status information associated with the data values which are stored in the respective cache units 114, 134. The particular cache coherency technique(s) implemented by the coherence controllers 118, 138 are beyond the scope of this disclosure.

In one embodiment, coherence controllers 118, 138 may be implemented as logical units such as, e.g., software or firmware executable on processors 110, 130. In alternate embodiments, coherence controllers may be implemented as logic circuitry on processors 110, 130.

Memory 160 includes an operating system 180 for managing operations of apparatus 100. In operation, one or more application modules 162 and/or libraries 164 executing on computer 108 make calls to the operating system 180 to execute one or more commands on the computer's processor. The operating system 180, in turn, invokes the services of processors 110, 130 and other system hardware to execute the command(s). The operating system kernel 182 can be generally considered as one or more software modules that are responsible for performing many operating system functions.

The various device drivers 184 interface with and generally control the hardware installed in the apparatus 100. A driver communicates with other drivers and the operating system components (e.g., an I/O manager or the kernel 182), for example in the Windows® 2000 operating system, by passing messages called I/O request packets (IRPs) up and down a “driver stack.” As will be understood by those skilled in the art, drivers for a particular hardware device may be “stacked” such that messages directed either down to the hardware device or back up to the operating system (or other program module) are passed through a chain of drivers in a driver stack before reaching their destination.

In one embodiment, the kernel 182 interfaces with an Operating System Power Management (OSPM) module 186. The OSPM module 186 comprises one or more software modules that may be used to modify the behavior of certain components of the computer system 100, typically to mange power consumption in accordance with pre-configured constraints/power conservation settings.

For example, in one embodiment, OSPM module 186 may implement ACPI power management protocols to transition the apparatus 100, or devices connected to the apparatus 100, between power management states. Advanced Control and Power Interface (ACPI) is a specification that makes hardware status information available to an operating system in computers, including laptops, desktop, servers, etc. More information about ACPI may be found in the Advanced Configuration and Power Interface Specification, Revision 2.0a, Mar. 31, 2002, cooperatively defined by Compaq Computer Corporation, Intel Corporation, Microsoft Corporation, Phoenix Technologies Ltd., and Toshiba Corporation. The ACPI specification was developed to establish industry common interfaces enabling robust operating system (OS)-directed motherboard device configuration and power management of both devices and entire systems.

The ACPI specification defines multiple power management states in which the apparatus 100, the computer processor, or various devices connected to the apparatus 100 may reside. Global system power states include: G3 (Mechanical Off), G2 (Soft Off), G1 (Sleeping) and G0 (Working). Device power states include: D3 (Off), D0 (Fully On) and D1 and D2, which are device-dependent states. Processor power states include: C0 (Instruction state), C1 (Low Latency), C2 and C3, which are power saving states. Sleeping states include: S1 (Hardware maintains system context), S2 (CPU and system cache context lost), S3 (CPU, system cache, and chipset context lost), and S4 (only platform context is maintained), and S5, which requires a complete re-boot of the system. Particular details about various power management states are described in the ACPI specification, and are beyond the scope of this disclosure.

It will be understood that in some embodiments power configuration may be implemented according to protocols other than the ACPI protocol.

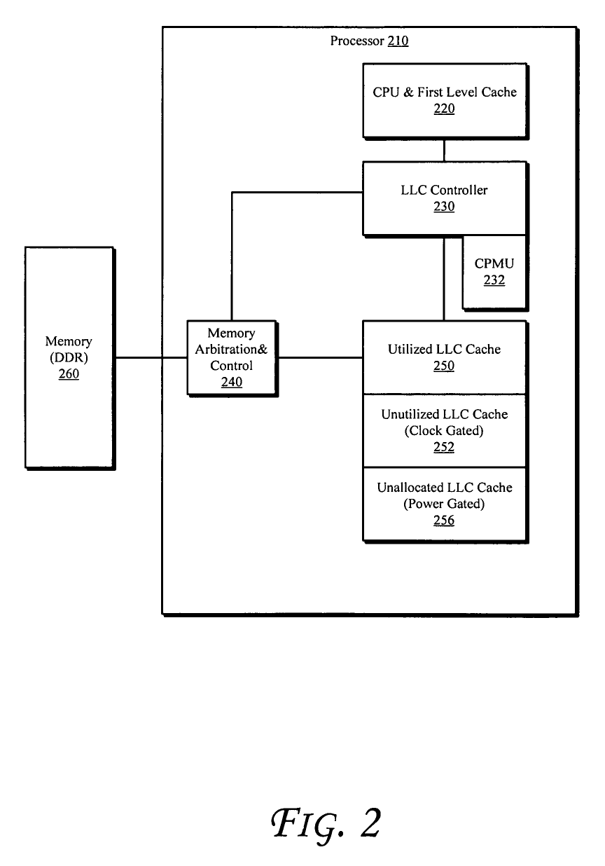

FIG. 2 is a schematic illustration of a memory configuration in a processor in an electronic apparatus, according to embodiments. Referring to FIG. 2, processor 210 may correspond to one of processors 110, 130 depicted in FIG. 1. In the embodiment depicted in FIG. 2, processor 210 comprises a central processing unit (CPU) and L1/L2 cache 220 coupled to a last level cache (LLC) controller 230. A memory arbitration and control module 240 couples the LLC controller 230 to external memory 260.

In the embodiment depicted in FIG. 2, a cache performance monitoring unit (CPMU) 232 is coupled to the LLC controller 230. In practice, the CPMU 232 may be implemented as logic instructions executable on LLC controller 230, or may be reduced to hard-wired circuitry. In some embodiments, the CPMU 232 and the LLC controller 230 cooperates with the OSPM module 186 to manage the power state of cache memory such that a portion of the cache memory is utilized LLC cache 250, a portion of the cache memory is unutilized LLC cache 252. In one aspect, the CPMU 232 and the LLC controller 230 cooperates with the OSPM module 186 to minimize, or at least to reduce, the amount of off-chip memory access without sacrificing active and/or leakage power of a second and higher level cache. In some embodiments, the CPMU 232 and the LLC controller 230 cooperates with the OSPM module 186 to dynamically provide the optimal power efficient configuration.

Referring back to FIG. 1, the OSPM module 186 has visibility into performance and resource requirements for a given workload for an electronic device such as electronic device 100. This information can either be dynamically extracted from the electronic device or defined in tables which OSPM module 186 uses to control configuration and policy for the platform power management, as described above. In some embodiments, information from the tables may be used in conjunction with information obtained dynamically during operation of the electronic device to manage power and performance attributes of the LLC.

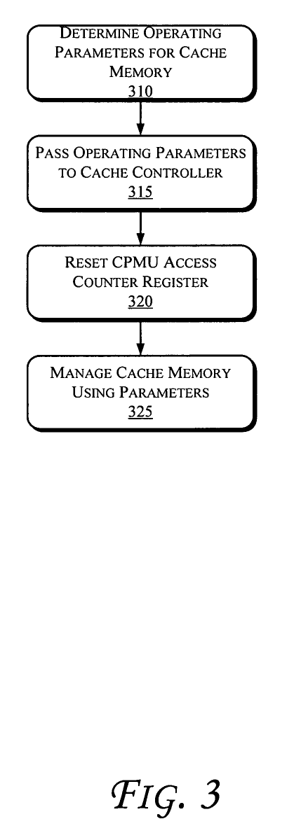

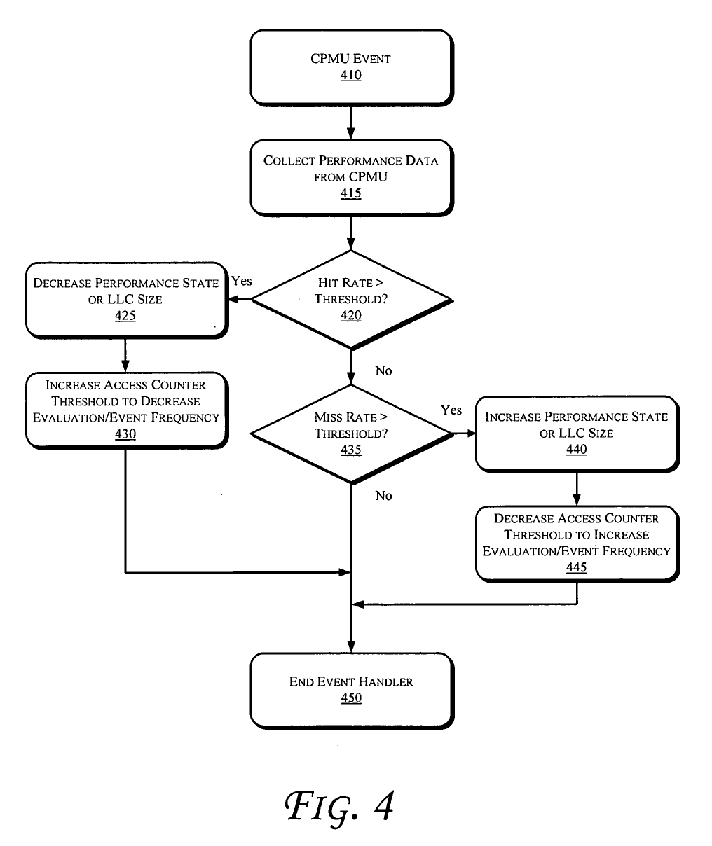

FIGS. 3 and 4 are flow diagrams which illustrate cache management operations, according to an embodiment. Referring to FIG. 3, at operation 310 the OSPM module 186 determines operating parameters for cache memory. In some embodiments, the OSPM module 186 determines the current operating mode of the platform based upon driver, service, and application events and/or information. Once the OSPM module 186 determines the current operating mode, various platform power management facilities (e.g., cache clock and power gating, latency requirements, and performance requirements) are configured. In some embodiments, the OSPM module 186 may obtain configuration information from ACPI tables which are indexed by the operating mode. In some embodiments, the table entries may also contain LLC configuration constraints. These constraints, which are based upon known attributes of the given workload, determine the min and max LLC cache size, as well as performance attributes, such as frequency.

At operation 315, the OSPM module 186 passes the operating parameters obtained from the tables to the LLC controller 230, e.g., by means of machine specific register (MSR) writes. In alternate embodiments, the parameters may be passed by other mechanisms, including but not limited to input/output transactions, MMIO, and IPC mechanisms. In some embodiments, the CPMU 232 contain counters which indicate the number of LLC hit's, misses, stall cycle count, and snoop cycle flushes. The CPMU 232 maintains a count of each of the above mentioned events. The event count will be reflected in registers in the CPMU. Upon setting of the min/max caches sizes, the LLC controller 232 will clear these counters (operation 320).

Once these constraints are established, OSPM module 186 uses the CMPU 232 to manage performance of the LLC. The LLC controller 230 manages cache coherency of any affected blocks and power gates SRAM blocks which are not used (e.g., based upon the max size parameter).

In some embodiments the CPMU generates one or more events which cause the OSPM module 186 to perform an evaluation of the performance parameters and characteristics of the LLC. During the evaluation cycle, OSPM module 186 can adjust the performance state of the LLC based on performance data. For example, the OSPM module can either adjust the cache size to the next incremental size (depending upon either a promotion of demotion of state), and/or adjusting the frequency of the LLC. The adjustments may be constrained by the min/max size parameters established during the mode change.

Two additional mechanisms can be used to generate events. One mechanism is an internal timer which can simply generate an event upon expiration of the timer. The other mechanism involves the depletion of an access counter. Each access to the LLC (e.g., from core or snoop) decrements the access counter. When the counter reaches zero, an event can be generated. Both mechanisms provide a means for the OSPM module 186 to do an evaluation of the current set of performance data. The access counter is the preferred method as this provides a more efficient power and performance based evaluation metric.

Referring now to FIG. 4, when a CPMU event is generated (operation 410), the OSPM module 186 collects performance data from the CPMU. As described above, the performance data may include the number of LLC hit's, misses, stall cycle count, and snoop cycle flushes. If, at operation 420, the cache hit rate exceeds a threshold, then control passes to operation 425 and at least one of performance rate or the LLC cache size are decreased. When the cache is down-sized (i.e., through disabling of sets), the LLC controller 230 will manage syncing any dirty lines to main memory and then clock gate the SRAM blocks which were de-allocated. Control then passes to operation 430 and the access counter threshold is increased to decrease the evaluation/event frequency.

By contrast, if at operation 420 the hit rate does not exceed a threshold, then control passes to operation 435. If, at operation 435, the miss rate exceeds a threshold, then control passes to operation 440 and at least one of performance rate or the LLC cache size are increased. When the cache is up-sized, the LLC 230 will remove any clock gating for the given blocks and open up the additional ways/sets. Control then passes to operation 445 and the access counter threshold is decreased to increase the evaluation/event frequency. After completion of these actions, the CPMU 232 will be informed and all performance counters are reset.

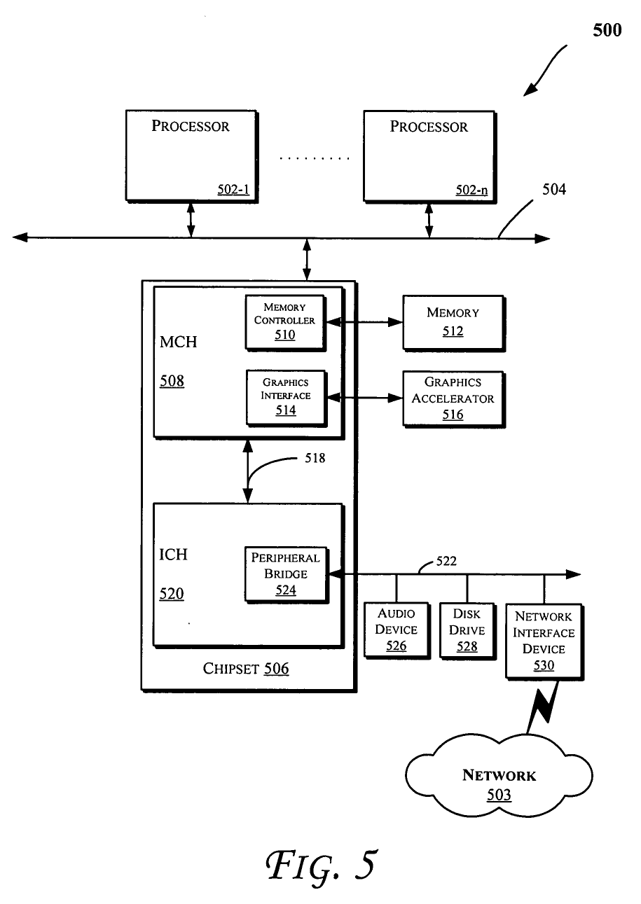

In embodiments, the operations of FIGS. 3-4 may be implemented within a computing system. FIG. 5 illustrates a block diagram of a computing system 500 in accordance with an embodiment of the invention. The computing system 500 may include one or more central processing unit(s) (CPUs) 502 or processors in communication with an interconnection network (or bus) 504. The processors 502 may be any processor such as a general purpose processor, a network processor (that processes data communicated over a computer network 503), or other types of a processor (including a reduced instruction set computer (RISC) processor or a complex instruction set computer (CISC)). Moreover, the processors 502 may have a single or multiple core design. The processors 502 with a multiple core design may integrate different types of processor cores on the same integrated circuit (IC) die. Also, the processors 502 with a multiple core design may be implemented as symmetrical or asymmetrical multiprocessors.

A chipset 506 may also be in communication with the interconnection network 504. The chipset 506 may include a memory control hub (MCH) 508. The MCH 408 may include a memory controller 510 that communicates with a memory 512. The memory 512 may store data and sequences of instructions that are executed by the CPU 502, or any other device included in the computing system 500. In one embodiment of the invention, the memory 512 may include one or more volatile storage (or memory) devices such as random access memory (RAM), dynamic RAM (DRAM), synchronous DRAM (SDRAM), static RAM (SRAM), or other types of memory. Nonvolatile memory may also be utilized such as a hard disk. Additional devices may communicate through the interconnection network 404, such as multiple CPUs and/or multiple system memories.

The MCH 508 may also include a graphics interface 514 that communicates with a graphics accelerator 516. In one embodiment of the invention, the graphics interface 514 may be in communication with the graphics accelerator 516 via an accelerated graphics port (AGP). In an embodiment of the invention, a display (such as a flat panel display) may communicate with the graphics interface 514 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 518 may allow the MCH 508 to communicate with an input/output control hub (ICH) 520. The ICH 520 may provide an interface to I/O devices that communicate with the computing system 500. The ICH 520 may communicate with a bus 522 through a peripheral bridge (or controller) 524, such as a peripheral component interconnect (PCI) bridge, a universal serial bus (USB) controller, or other types of a bus. The bridge 524 may provide a data path between the CPU 502 and peripheral devices. Other types of topologies may be utilized. Also, multiple buses may communicate with the ICH 520, e.g., through multiple bridges or controllers. Moreover, other peripherals in communication with the ICH 520 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other types of peripherals.

The bus 522 may communicate with an audio device 526, one or more disk drive(s) 528, and a network interface device 530 (which may be in communication with the computer network 503). Other devices may communicate through the bus 522. Also, various components (such as the network interface device 530) may be in communication with the MCH 508 in some embodiments of the invention. In addition, the processor 502 and the MCH 508 may be combined to form a single chip. Furthermore, the graphics accelerator 516 may be included within the MCH 508 in other embodiments of the invention.

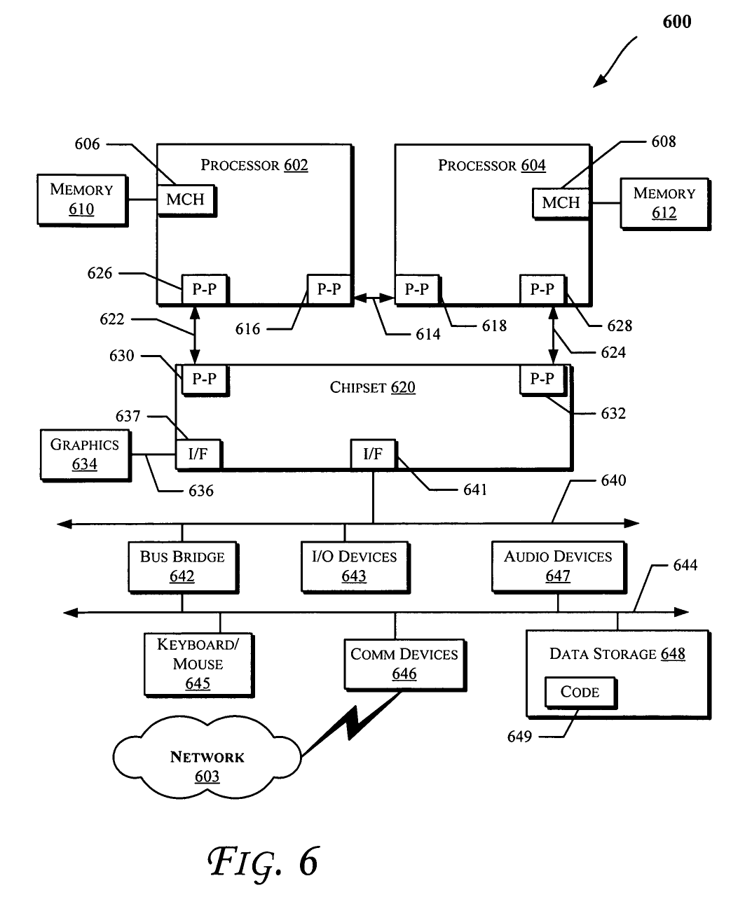

Furthermore, the computing system 500 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 528), a floppy disk, a compact disk ROM (CD-ROM), a digital versatile disk (DVD), flash memory, a magneto-optical disk, or other types of nonvolatile machine-readable media capable of storing electronic instructions and/or data. FIG. 6 illustrates a computing system 600 that is arranged in a point-to-point (PtP) configuration, according to an embodiment of the invention. In particular, FIG. 6 shows a system where processors, memory, and input/output devices are interconnected by a number of point-to-point interfaces.

As illustrated in FIG. 6, the system 600 may include several processors, of which only two, processors 602 and 604 are shown for clarity. The processors 602 and 604 may each include a local memory controller hub (MCH) 606 and 608 to communicate with memories 610 and 612. The memories 610 and/or 612 may store various data such as those discussed with reference to the memory 612.

The processors 602 and 604 may be any type of a processor such as those discussed with reference to the processors 402 of FIG. 4. The processors 602 and 604 may exchange data via a point-to-point (PtP) interface 614 using PtP interface circuits 616 and 618, respectively. The processors 602 and 604 may each exchange data with a chipset 620 via individual PtP interfaces 622 and 624 using point to point interface circuits 626, 628, 630, and 632. The chipset 620 may also exchange data with a high-performance graphics circuit 634 via a high-performance graphics interface 636, using a PtP interface circuit 637.

At least one embodiment of the invention may be provided within the processors 602 and 604. Other embodiments of the invention, however, may exist in other circuits, logic units, or devices within the system 600 of FIG. 6. Furthermore, other embodiments of the invention may be distributed throughout several circuits, logic units, or devices illustrated in FIG. 6.

The chipset 620 may be in communication with a bus 640 using a PtP interface circuit 641. The bus 640 may have one or more devices that communicate with it, such as a bus bridge 642 and I/O devices 643. Via a bus 644, the bus bridge 643 may be in communication with other devices such as a keyboard/mouse 645, communication devices 646 (such as modems, network interface devices, or other types of communication devices that may be communicate through the computer network 603), audio I/O device, and/or a data storage device 648. The data storage device 648 may store code 649 that may be executed by the processors 602 and/or 604.

The computer systems depicted in FIGS. 5 and 6 are schematic illustrations of embodiments of computing systems which may be utilized to implement various embodiments discussed herein. It will be appreciated that various components of the systems depicted in FIGS. 5 and 6 may be combined in a system-on-a-chip (SoC) architecture.

In various embodiments of the invention, the operations discussed herein, e.g., with reference to FIGS. 2 and 3, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include any type of a storage device such as those discussed with respect to FIGS. 5 and 6.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method to manage cache memory in an electronic device, comprising:
determining, in a power management module operating on the electronic device, at least one operating parameter for the cache memory;
passing the at least one operating parameter for the cache memory to a cache controller;
managing the cache memory according to the at least one operating parameter;
evaluating, in the power management module, operating data for the cache memory from the cache controller; and
generating, in the power management module, at least one modified operating parameter for the cache memory based on the operating data for the cache memory from the cache controller.

2. The method of claim 1, further comprising:
passing the at least one modified operating parameter for the cache memory to the cache controller; and
managing the cache memory according to the at least one modified operating parameter.

3. The method of claim 1, wherein determining, in a power management module operating on the electronic device, at least one operating parameter for the cache memory comprises at least one of determining a workload parameter for the electronic device from a table or determining a workload parameter in real-time from operating conditions on the electronic device.

4. The method of claim 1, wherein determining, in a power management module operating on the electronic device, at least one operating parameter for the cache memory comprises determining at least one of a minimum cache size, a maximum cache size, or a cache frequency.

5. The method of claim 1, wherein managing the cache memory according to the at least one operating parameter comprises at least one of:
clock gating at least one cache memory block; or
power gating at least one cache memory block.

6. The method of claim 1, wherein evaluating, in the power management module, operating data for the cache memory from the cache controller comprises evaluating at least one of a cache hit count, a cache miss count, a stall cycle count or a snoop cycle flush count.

7. An electronic device comprising:
a processing unit, a cache memory, and a cache controller, and a power management module,
wherein the power management module:
determines at least one operating parameter for the cache memory; and
passes the at least one operating parameter for the cache memory to a cache controller; and
wherein the cache controller manages the cache memory according to the at least one operating parameter; and
wherein the power management module:
evaluates, in the power management module, operating data for the cache memory from the cache controller; and
generates, in the power management module, at least one modified operating parameter for the cache memory based on the operating data for the cache memory from the cache controller.

8. The electronic device of claim 7, wherein:
the power management module further passes the at least one modified operating parameter for the cache memory to the cache controller; and
the cache controller manages the cache memory according to the at least one modified operating parameter.

9. The electronic device of claim 7, wherein the power management module operating on the electronic device determines at least one of determining a workload parameter for the electronic device from a table or or determining a workload parameter in real-time from operating conditions on the electronic device.

10. The electronic device of claim 7, wherein the power management module operating on the electronic device determines at least one of a minimum cache size, a maximum cache size, or a cache frequency.

11. The electronic device of claim 7, wherein first cache controller performs at least one of:
clock gating at least one cache memory block; or
power gating at least one cache memory block.

12. The electronic device of claim 7, wherein the power management module operating on the electronic device evaluates at least one of a cache hit count, a cache miss count, a stall cycle count and a snoop cycle flush count.

13. A system comprising:
at least one network interface card; and
a processing unit, a first cache memory, and a first cache controller, and a power management module,
wherein the power management module:
determines at least one operating parameter for the cache memory; and
passes the at least one operating parameter for the cache memory to a cache controller; and
wherein the cache controller manages the cache memory according to the at least one operating parameter; and
wherein the power management module:
evaluates, in the power management module, operating data for the cache memory from the cache controller; and
generates, in the power management module, at least one modified operating parameter for the cache memory based on the operating data for the cache memory from the cache controller.

14. The system of claim 13, wherein:
the power management module further passes the at least one modified operating parameter for the cache memory to the cache controller; and
the cache controller manages the cache memory according to the at least one modified operating parameter.

15. The system of claim 13, wherein the power management module determines at least one of determining a workload parameter from a table or determining a workload parameter in real-time from operating conditions.

16. The system of claim 13, wherein the power management module determines at least one of a minimum cache size, a maximum cache size, or a cache frequency.

17. The system of claim 13, wherein first cache controller performs at least one of:
clock gating at least one cache memory block; or
power gating at least one cache memory block.

18. The system of claim 13, wherein the power management module evaluates at least one of a cache hit count, a cache miss count, a stall cycle count and a snoop cycle flush count.
